(19) United States
(12) Patent Application Publication
(10) Pub. No.: US 2019/0373222 A1
(43) Pub. Date: Dec. 5, 2019

(54) PORTABLE REMOTE SURVEILLANCE DEVICE AND SYSTEM

(71) Applicant: ERA DIGITAL MEDIA CO., LTD., Taipei City (TW)

(72) Inventor: FU-SHENG CHIU, TAIPEI CITY (TW)

(21) Appl. No.: 15/991,129

(22) Filed: May 29, 2018

(51) Int. Cl. H04N 7/18; G08B 13/196; G08B 13/16; G08B 13/19; G06F 1/26; G01S 19/13; H04L 29/08

(52) U.S. Cl. CPC H04N 7/185; G08B 13/19602; G08B 13/1672; H04L 67/12; G06F 1/26; G01S 19/13; G08B 13/19

(57) ABSTRACT

A portable remote surveillance device and monitoring system that allows remote collection of sensor data, sound, and imaging data, while not requiring power to drive motion to change location of the surveillance device. The surveillance device comprises a plurality of data collection components for obtaining data from a current location's environment and a plurality of action controllers for providing action signals to alter location of the portable remote surveillance device. The current location of the portable remote surveillance device is determined. Sensor data, image data, and audio data via sensors, camera, and microphone are obtained and transmitted to a server. The data is analyzed and a desired action is determined. Control data associated with the desired action is sent to action controllers of the portable remote surveillance device. An action by an appropriate action controller is performed according to the received control data.

### BACKGROUND OF THE INVENTION

### Field of the Invention

The present invention relates to surveillance systems. More specifically, the present invention discloses a platform and method for providing portable remote surveillance devices for collecting data that do not require additional power to change the locations of the portable remote surveillance devices.

### Description of the Prior Art

Conventional surveillance devices are cameras mounted to walls or ceilings and are unmovable. Since the cameras have a fixed area of image capture, their efficacy is limited.

Recently, drones have increased in popularity. Cameras mounted on the drones can capture images from various locations. However, the drones require a significant amount of power to drive the blades in order to keep the drone in the air. As a result, the drones can only travel a short distance before having to return to home base in order to replace the battery or refuel.

Therefore, there is need for an efficient portable remote surveillance device and monitoring system that allows remote collection of sensor data, sound, and imaging data, while not requiring power to drive motion to change location of the surveillance device.

### SUMMARY OF THE INVENTION

To achieve these and other advantages and in order to overcome the disadvantages of the conventional method in accordance with the purpose of the invention as embodied and broadly described herein, the present invention provides a portable remote surveillance device and monitoring system that allows remote collection of sensor data, sound, and imaging data, while not requiring power to drive motion to change location of the surveillance device. The surveillance device comprises a plurality of data collection components for obtaining data from a current location's environment and a plurality of action controllers for providing action signals to alter location of the portable remote surveillance device. The current location of the portable remote surveillance device is determined. Sensor data, image data, and audio data via sensors, camera, and microphone are obtained and transmitted to a server. The data is analyzed and a desired action is determined. Control data associated with the desired action is sent to action controllers of the portable remote surveillance device. An action by an appropriate action controller is performed according to the received control data.

The portable remote surveillance device is a wearable electronic device the is attached to the head or around the neck of a living being such as a human being or animal.

A camera continuously records image data and a microphone records sound data. Various sensors obtain and collect sensor data. The obtained image, sound, and sensor data is sent to a server where the data is analyzed. The current location of the surveillance device is considered along with the received data.

A desired action such as, for example, a “turn left” or “stop” action is determined. Control and/or command data associated with the desired action is identified and transmitted to the portable remote surveillance device. Using the control data, the central processing unit controller of the surveillance device instructs the appropriate action controller to perform an action.

In response to the action of the action controller, the wearer of the surveillance will perform the desired action. For example, an audio command is emitted from audio speakers to instruct the wearer of the surveillance device to stop.

Since the wearer of the surveillance device is a living being, the surveillance device does not require an expensive and inefficient power source to move the location of the surveillance device. For example, if the wearer is a bird, extensive aerial image data and sensor data can be easily and inexpensively collected from a great area or distance. Or for example, the wearer is a dog and vital image data and sensor data can be safely obtained from a dangerous or unsafe location.

The server receives the image and sound data and formats it into media content and streams the media to a plurality of user devices. In this way a unique television broadcast is inexpensively created.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating a portable remote surveillance device according to an embodiment of the present invention;

FIG. 2 is a diagram illustrating a portable remote surveillance system according to an embodiment of the present invention; and

FIG. 3 is a flowchart illustrating a method for obtaining data from a remote location by a portable remote surveillance device according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

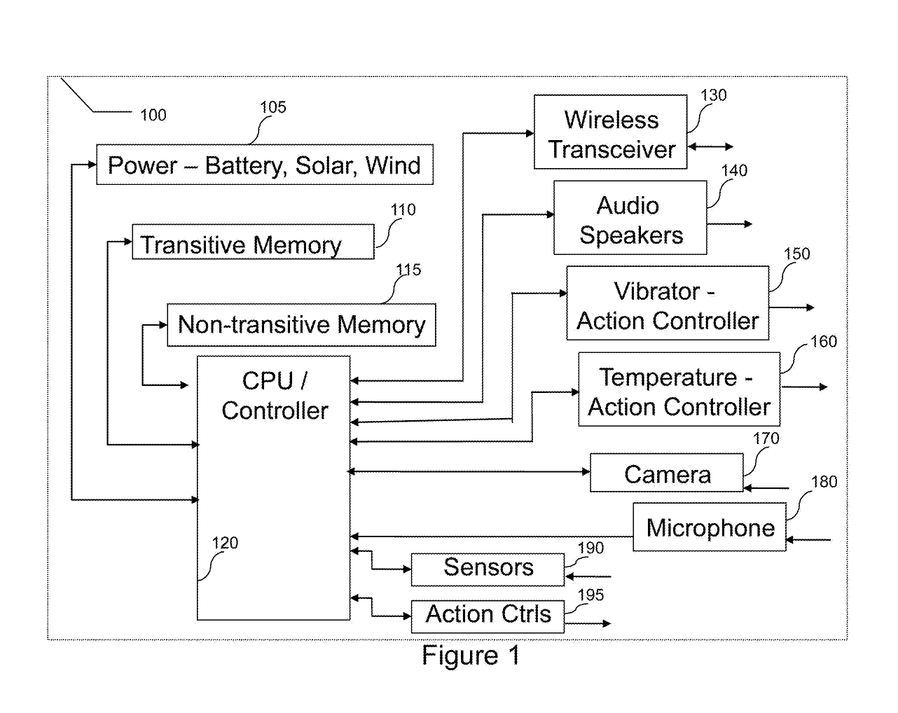

Refer to FIG. 1. The portable remote surveillance device 100 of the present invention comprises a central processing unit (CPU) 120 that operates as a controller for controlling operation of the components of the portable remote surveillance device 100.

A wireless transceiver 130 communicates with a central server and sends data collected by the surveillance device 100 to the central server and receives control data sent by the central server.

A volatile or transitive memory 110 and a non-volatile or non-transitive memory 115 are provided for storing data collected by various components of the portable remote surveillance device or received by the wireless transceiver 130.

The portable remote surveillance device 100 further comprises a plurality of sensors or data collection components that obtain data from the current location's environment and a plurality of action controllers that provide action signals to alter the device's location or position.

The plurality of data collection components comprises, for example, a camera 170, a microphone 180, and sensors 190 such as infrared sensors, motion sensors, temperature sensor, thermometer, altitude sensors, barometric pressure sensors, wind speed sensors, speed sensors, etc.

The camera 170 collects video data of the surveillance device's location and continually collects image data as the device is moved.

In an embodiment of the present invention, the portable remote surveillance device 100 is attached or positioned on the wearer's head so that the image data collected by the camera 170 is from the line of sight of the wearer. As a result, video data from a first person perspective of the wearer is obtained. As the wearer turns its head the camera 170 follows the line of sight of the wearer's eyes.

The microphone 180 collects audio data from the surveillance device's location/environment and continually collects image data as the device is moved.

The infrared sensor collects infrared image data, the motion sensors collect motion and movement data, the temperature sensor and thermometer collect temperature and temperature change data, the altitude sensor collects the altitude data, and the speed sensor collects speed data of the speed of movement of the surveillance device.

The plurality of action controllers are capable of commanding the wearer of the portable remote surveillance device 100 to perform a specific action. The plurality of action controllers comprises, for example, audio speakers 140, vibrator action controllers 150, temperature action controllers 160, and action controllers 195 such as pressure application controllers, rein controllers, electrical shock controllers, etc.

The audio speakers 140 provide audio to the wearer. The stereo audio speakers 140 allow audio data such as, for example, spoken commands or audio signals to be emitted to the wearer of the portable remote surveillance device 100 which will cause the wearer to respond with an associated reaction or response.

For example, the audio commands emitted by the audio speakers 140 comprise Gee—Command for right turn, Haw—Command for left turn, Line out, Mush, Whoa, Left, Right, Ahead, Stop, Sit, Stay, Heel. When these commands are emitted from the audio speakers 140, the wearer will respond with the associated response.

Other types of audio signals that can control the behavior or movement of the wearer are high pitched audio signals or non-language based audio sounds. For example, emitting a sound from the left audio speaker 140 can cause the wearer to turn right to avoid the sound or emitting a sound from the right audio speaker 140 can cause the wearer to turn left.

Also, speaking a welcoming term or phrase can cause the wearer to approach the sound in the direction of the sound. For example, “here boy” emitted from the right audio speaker 140 can cause the wearer to proceed to the right.

The vibrator action controller 150 allows a vibration signal to be applied to the wearer. The frequency and velocity of the vibration can cause the wearer to respond in different manners and with different actions.

The temperature action controllers 160 allows a temperature to be applied to the wearer. The hot or cold temperature of the applied temperature can cause the wearer to respond in different manners and with different actions.

Other action controllers 195 are provided to cause various reactions or responses by the wearer. For example, a pressure application controller applies a pressure to the wearer, a rein controller pulls on a left or right rein, an electrical shock controller applies an electric shock to the wearer.

A power supply/power generator module 105 is provided for supplying and/or generating power for the electrical components of the of the surveillance device 100.

For example, the power supply/power generator module 105 comprises a rechargeable battery, a solar power generator, or a wind generator.

Note that power is only required for operation of the surveillance device 100 and power is not required to move the surveillance device from location to location.

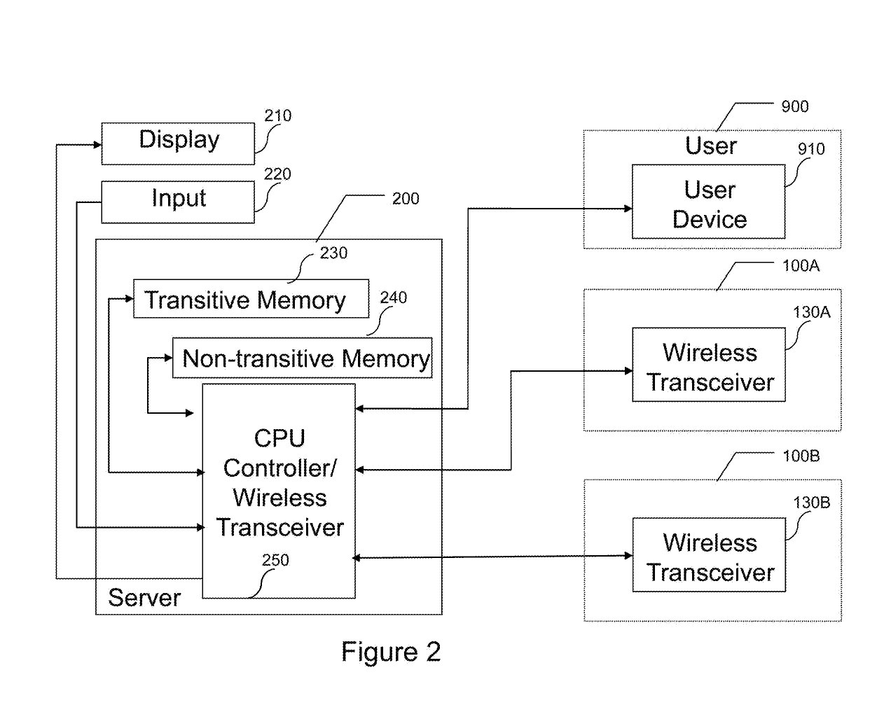

Refer to FIG. 2. The portable remote surveillance system of the present invention comprises a server 200 for communicating with the portable remote surveillance device 100A,100B.

The server 200 comprises a controller 250 that operates as a controller for controlling operation of the components of the server 200. The controller 250 comprises a central processing unit (CPU) and a wireless transceiver that communicates with the surveillance device 110A,110B and receives data collected by the surveillance device 100 and sends control data to the surveillance device 110A,110B.

A volatile or transitive memory 230 and a non-volatile or non-transitive memory 240 are provided for storing data received from the surveillance device 110A,110B, firmware, server software, application software, and surveillance system data.

A display 210 and input means such as a keyboard or touch pad are provided for input/output operation and control.

The server 200 communicates with at least one portable remote surveillance device 100A,100B wirelessly transmitting commands or control signals to the surveillance device and wirelessly receiving sensor data from the surveillance device.

Additionally, the server 200 communicates with user devices 910. In an embodiment of the present invention the user can request audio/video media acquired by the surveillance devices 110A,110B. In another embodiment of the present invention the user 900 via the user device 910 and the server 200 to issue action control signals or commands to the surveillance device 100A,100B.

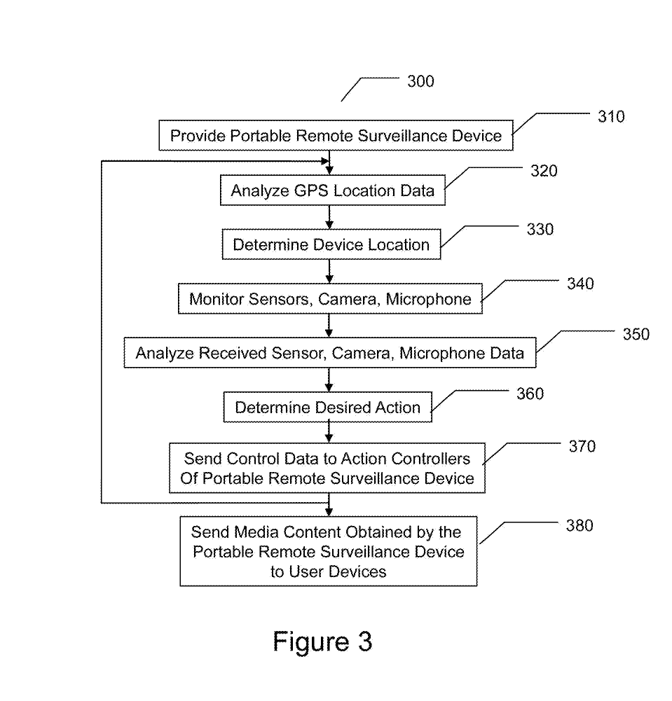

Refer to FIG. 3. The method for obtaining data from a remote location by a portable remote surveillance device 300 according to an embodiment of the present invention begins in Step 310 by providing a portable remote surveillance device as described in regard to FIG. 1.

In Step 320 the server receives global positioning satellite (GPS) data that represents the current location of the portable remote surveillance device. The GPS data is analyzed.

Next, the server determines the current location of the portable remote surveillance device in Step 330. The location of the device affects various considerations for the following steps.

In Step 340, the surveillance device obtains data via the device's sensors and transmits the data to the server. The server monitors the sensor, camera, and microphone data.

Then, in Step 350, the server analyzes the received sensor, camera, and microphone data.

According to the analysis results, a desired action is determined in Step 360. The desired action is what response or reaction the user is to be requested to perform.

In Step 370 the associated command and control data are sent to the action controllers of the portable remote surveillance device. Upon receiving the control data the appropriate action controller will perform the commanded action which results in the wearer responding to the action and performing the desired action.

Steps 320 through 370 are continually repeated.

Media content obtained by the portable remote surveillance device is sent to user devices in Step 380.

In an embodiment of the present invention the portable remote surveillance device and system comprises utilizing global positioning satellite data in addition to data obtained by the surveillance device to determine commands to issue to the device.

In an embodiment of the present invention the device comprises a neckband that allows 360 degree positions around the neckband to utilize vibration position to indicate direction and vibration frequency to indicate speed of movement for the wearer to move.

In an embodiment of the present invention the device comprises ear modules that allow left, right, forward, or reverse commands to be issued by utilizing vibration signals to the ear modules to indicate direction and vibration frequency to indicate speed of movement to move.

In an embodiment of the present invention at least one real-time voice command is issued to the portable remote surveillance device.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A portable remote surveillance device and system comprising:
a central processing unit for controlling operation of the portable remote surveillance device;
a wireless transceiver for communicating with a server and sending data collected by the portable remote surveillance device to the server and receiving control data sent by the server;
a transitive memory and a non-transitive memory for storing data collected by components of the portable remote surveillance device or received by the wireless transceiver from the server;
a plurality of data collection components for obtaining data from a current location's environment; and
a plurality of action controllers for providing action signals to alter location of the portable remote surveillance device.

2. The portable remote surveillance device and system of claim 1, the plurality of data collection components comprising a camera, a microphone, infrared sensors, motion sensors, temperature sensors, a thermometer, altitude sensors, barometric pressure sensors, wind speed sensors, or speed sensors.

3. The portable remote surveillance device and system of claim 1, the plurality of action controllers comprising audio speakers, vibrator action controllers, temperature action controllers, pressure application controllers, rein controllers, or electrical shock controllers.

4. The portable remote surveillance device and system of claim 1, further comprising:
a power supply/power generator module for generating and supplying power for electrical components of the of the portable remote surveillance device.

5. The portable remote surveillance device and system of claim 4, the power supply/power generator module comprising a rechargeable battery, a solar power generator, a wind generator, or a combination of a rechargeable battery, a solar power generator, and a wind generator.

6. A portable remote surveillance system comprising:
providing a wearable portable remote surveillance device;
receiving global positioning satellite (GPS) data by a server that represents a current location of the portable remote surveillance device;
analyzing the global positioning satellite data;
determining the current location of the portable remote surveillance device;
obtaining sensor data, image data, and audio data via sensors, camera, and microphone of the portable remote surveillance device;
transmitting sensor data, image data, and audio data to the server;
analyzing received sensor data, image data, and audio data by the server;
determining a desired action according to analysis results;
sending control data associated with the desired action to action controllers of the portable remote surveillance device; and
performing an action by the appropriate action controller according to received control data.

7. The portable remote surveillance system of claim 6, the sensor data, image data, and audio data obtained by a plurality of data collection components comprising a camera, a microphone, infrared sensors, motion sensors, temperature sensors, a thermometer, altitude sensors, barometric pressure sensors, wind speed sensors, or speed sensors.

8. The portable remote surveillance device and system of claim 6, the action controllers comprising audio speakers, vibrator action controllers, temperature action controllers, pressure application controllers, rein controllers, or electrical shock controllers.

9. The portable remote surveillance system of claim 6, further comprising:
repeatedly obtaining data from the sensors, camera, and microphone and sending control data associated with the desired action to the action controllers.

10. The portable remote surveillance system of claim 6, further comprising:
sending media content obtained by the portable remote surveillance device to user devices.

11. The portable remote surveillance system of claim 6, further comprising:
responding to action controllers by a wearer of the portable remote surveillance system; and
performing the desired action by the wearer.
